(19) United States
(12) Patent Application Publication
(10) Pub. No.: US 2026/0028461 A1
(43) Pub. Date: Jan. 29, 2026

(54) POLYESTER-BASED SHRINK FILM

(71) Applicants: C.I. TAKIRON Corporation, Osaka (JP); Bonset America Corporation, Browns Summit, NC (US)

(72) Inventors: Takuma KANEKO, Osaka (JP); Shuta YUGE, Osaka (JP); Tatsuya IRIFUNE, Osaka (JP); Ryuma UMINO, Osaka (JP)

(21) Appl. No.: 19/333,345

(22) Filed: Sep. 19, 2025

Related U.S. Application Data
(63) Continuation of application No. PCT/JP2024/002972, filed on Jan. 31, 2024.

(30) Foreign Application Priority Data
Mar. 28, 2023 (JP) 2023-050954

(51) Int. Cl. C08J 5/18; C08L 67/06

(52) U.S. Cl. CPC C08J 5/18; C08L 67/06; C08J 2367/06; C08J 2467/06; C08L 2203/16; C08L 2205/025; C08L 2207/20

(57) ABSTRACT

A heat-shrinkable polyester film is provided, in which the loss coefficient and the like are controlled in a plurality of temperature regions, and which has excellent wrinkle resistance characteristics. The heat-shrinkable polyester film is a heat-shrinkable polyester film derived from a polyester resin composition containing 30% to 90% by weight of an amorphous polyester resin and 10% to 70% by weight of a crystalline polyester resin with respect to the total amount, in which (a) a loss coefficient obtained using a dynamic viscoelasticity measuring apparatus has a first loss coefficient peak in a temperature region of below 100° C.; (b) a loss coefficient obtained in the same manner has a second loss coefficient peak in a temperature region of 100° C. or higher; and (c) a heat shrinkage ratio obtained when the film is immersed in hot water at 80° C. for 10 seconds is 30% or more.

### CROSS-REFERENCE TO RELATED APPLICATIONS

This application claims the benefit of priority and is a Continuation application of the prior International Patent Application No. PCT/JP2024/002972, with an international filing date of Jan. 31, 2024, which designated the United States, and is related to the Japanese Patent Application No. 2023-050954, filed Mar. 28, 2023, the entire disclosures of all applications are expressly incorporated by reference in their entirety herein.

### TECHNICAL FIELD

The present invention relates to a heat-shrinkable polyester film (sometimes called as a polyester-based shrink film or the like).

More particularly, the invention relates to a heat-shrinkable polyester film having excellent wrinkle resistance characteristics, in which loss coefficient peaks and the like measured using a dynamic viscoelasticity measuring apparatus (hereinafter, sometimes referred to as “DMA”) are controlled in a plurality of temperature regions.

### BACKGROUND ART

Conventionally, heat-shrinkable films have been widely used as base material films for labels on PET bottles and the like. In particular, polyester resins have excellent transparency and strength and are widely used. These heat-shrinkable films are caused to undergo heat shrinkage by passing through a tunnel that generates hot air or steam, and are fitted on containers; however, shrinkage differences (unevenness) may occur during heat shrinkage, causing the occurrence of wrinkles and color unevenness.

Thus, various heat-shrinkable polyester films for preventing the occurrence of wrinkles and the occurrence of color unevenness due to shrinkage differences (unevenness) produced during heat shrinkage, have been proposed.

For example, a heat-shrinkable polyester film which has a high heat shrinkage ratio in the width direction, exhibits a small heat shrinkage ratio in the longitudinal direction, has high mechanical strength in the longitudinal direction, has satisfactory perforated line openability, and also has excellent shrink-finishing property, has been proposed (see Patent Document 1).

More specifically, it is a biaxially stretched heat-shrinkable polyester film satisfying the following requirements (1) to (5).
(1) 1,4-Cyclohexanedimethanol is used as an amorphous monomer in an amount of 5 mol % or more and 30 mol % or less in 100 mol % of alcohol components,
(2) the hot water heat shrinkage ratio obtained when the film is immersed in hot water at 98° C. for 10 seconds is 60% or more and 90% or less in the film main shrinkage direction,
(3) the hot water heat shrinkage ratio obtained when the film is immersed in hot water at 98° C. for 10 seconds, is −5% or more and 5% or less in a direction orthogonally intersecting the film main shrinkage direction,
(4) the right-angle tear strength per unit thickness in a direction orthogonally intersecting the main shrinkage direction after the film is caused to shrink by 10% in the main shrinkage direction in hot water at 80° C., is 180 N/mm or more and 350 N/mm or less, and
(5) the maximum shrinkage stress in the film main shrinkage direction measured in hot air at 90° C. is 2 MPa or more and 10 MPa or less, and the shrinkage stress after 30 seconds from the start of measurement is 60% or more and 100% or less of the maximum shrinkage stress.

In addition, a heat-shrinkable polyester film has been proposed, in which the blending amount of amorphous components in all the polyester resin components is strictly controlled, and at the same time, the hot water heat shrinkage ratios at 80° C. and 90° C. in the film longitudinal direction and the hot water heat shrinkage ratio at 90° C. in the film width direction are limited (see Patent Document 2).

More specifically, it is a heat-shrinkable polyester film which has ethylene terephthalate as a main constituent component and contains one or more monomer components that may become amorphous components in all the polyester resin components, the total sum of which is 15 mol % or more.

Then, the polyester film is characterized in that the hot water heat shrinkage ratio in the film longitudinal direction is 30% or more at a treatment temperature of 80° C. for a treatment time of 10 seconds and is 40% or more at a treatment temperature of 90° C. for a treatment time of 10 seconds, and the hot water shrinkage ratio in the film width direction is 10% or less at 90° C. for a treatment time of 10 seconds.

### CITATION LIST

### Patent Document

Patent Document 1: JP 2019-081378 A (claims and the like)
Patent Document 2: JP 2007-016120 A (claims and the like)

### DISCLOSURE OF THE INVENTION

### Problem to be Solved by the Invention

However, with regard to both the heat-shrinkable films described in Patent Documents 1 and 2, the heat shrinkage ratio at a predetermined temperature in a predetermined shrinkage direction is restricted to be within a predetermined range; however, no consideration is given to quantitative controlling of the heat shrinkage ratio, the loss coefficient, and the like.

In particular, in the case of PET bottles and the like having complex shapes, in which the bottle diameter of the body part is not uniform, and the horizontal cross-sectional shape of the body part is not circular in some parts, since the heat shrinking property is likely to be non-uniform, there is a problem that it is very difficult to suppress the occurrence of fine wrinkles.

Thus, the inventors of the present invention have found that with regard to a heat-shrinkable polyester film derived from a predetermined polyester resin composition, the heat shrinkage characteristics, wrinkle resistance characteristics, and the like can be managed efficiently and precisely by controlling the loss coefficient and the like in a plurality of temperature regions to be each within a predetermined range, by using a dynamic viscoelasticity measuring apparatus.

That is, it is an object of the present invention to provide a heat-shrinkable polyester film having more uniform heat shrinkage characteristics and excellent wrinkle resistance characteristics using a predetermined simple measurement method.

### Means for Solving Problem

According to the present invention, there is provided a heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a) to (c), and the above-described problems can be solved.

Configuration (a): A loss coefficient obtained using a dynamic viscoelasticity measuring apparatus according to JIS K 7244-4 has a first loss coefficient peak in a temperature region of below 100° C.

Configuration (b): A loss coefficient obtained using a dynamic viscoelasticity measuring apparatus according to JIS K 7244-4 has a second loss coefficient peak in a temperature region of 100° C. or higher.

Configuration (c): A heat shrinkage ratio in a main shrinkage direction obtained when the heat-shrinkable polyester film is immersed in hot water at 80° C. for 10 seconds, is 30% or more.

That is, for a heat-shrinkable polyester film derived from a predetermined blend composition, when the loss coefficient (tan δ) obtained using a dynamic viscoelasticity measuring apparatus has peaks in a plurality of temperature regions (a first loss coefficient peak and a second loss coefficient peak), the heat shrinkage ratio can be precisely controlled in a wide temperature range, and the wrinkle resistance characteristics can be improved.

Upon configuring the heat-shrinkable polyester film of the present invention, it is preferable that a temperature region having the first loss coefficient peak has a value within a range of 70° C. to 90° C.

By controlling the temperature region having the first loss coefficient peak in this way, the difference from the second loss coefficient peak becomes clearer, and it is easier to adjust the heat shrinkage ratio in a wide temperature range and to adjust mechanical characteristics and durability.

Upon configuring the heat-shrinkable polyester film of the present invention, it is preferable that a temperature region having the second loss coefficient peak has a value within a range of 120° C. to 160° C.

By controlling the temperature region having the second loss coefficient peak in this way, the difference from the first loss coefficient peak is made clearer, and it is easier to adjust the heat shrinkage ratio in a wide temperature range and to adjust mechanical characteristics and durability.

Upon configuring the heat-shrinkable polyester film of the present invention, it is preferable that when a height of the first loss coefficient peak is 100, a height of the second loss coefficient peak has a value within a range of 20 to 50.

By controlling the ratio of height of first loss coefficient peak/height of second loss coefficient peak in this way, it is easier to adjust the heat shrinkage ratio in a wide temperature range and to adjust mechanical characteristics and durability.

Upon configuring the heat-shrinkable polyester film of the present invention, it is preferable that an intrinsic viscosity of the amorphous polyester resin has a value within a range of 0.6 to 0.85 dL/g, and an intrinsic viscosity of the crystalline polyester resin has a value within a range of 0.6 to 0.85 dL/g.

By controlling each of the intrinsic viscosity of the amorphous polyester resin and the intrinsic viscosity of the crystalline polyester resin to be in such a range, not only is mixing dispersibility improved while partial phase separation occurs, but it is also easier to adjust the heat shrinkage ratio and to adjust mechanical characteristics and durability.

Upon configuring the heat-shrinkable polyester film of the present invention, it is preferable that the crystalline polyester resin is a homo-PET resin and a PCRPET resin, or either of them.

By controlling the type of the crystalline polyester resin in this way, it is easy to adjust the heat shrinkage ratio and to adjust mechanical characteristics and durability, and furthermore, environmental characteristics are taken into consideration.

Furthermore, according to another aspect of the present invention, there is provided a heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a′) to (c′).

Configuration (a′): A storage modulus curve obtained using a dynamic viscoelasticity measuring apparatus according to JIS K 7244-4 has a first inflection point at which storage modulus decreases, in a temperature region of below 100° C.

Configuration (b′): A storage modulus curve obtained using a dynamic viscoelasticity measuring apparatus according to JIS K 7244-4 has a second inflection point at which storage modulus increases, in a temperature region of 100° C. or higher.

Configuration (c′): A heat shrinkage ratio in a main shrinkage direction obtained when the heat-shrinkable polyester film is immersed in hot water at 80° C. for 10 seconds is 30% or more.

That is, for a heat-shrinkable polyester film derived from a predetermined blend composition, when a storage modulus curve obtained using a dynamic viscoelasticity measuring apparatus (DMA) has a descending inflection point (first inflection point) at which the storage modulus decreases, and a deflection point (second deflection point) at which the storage modulus increases, each in a different temperature region, the balance between a glassy region and a rubber elastic region is improved, the heat shrinkage ratio at a predetermined temperature could be precisely controlled, and furthermore, the wrinkle resistance characteristics could be improved.

According to still another aspect of the present invention, there is provided a heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a″) to (c″).

Configuration (a″): A loss modulus curve obtained using a dynamic viscoelasticity measuring apparatus according to JIS K 7244-4 has a first loss modulus peak in a temperature region of below 100° C.

Configuration (b″): A loss modulus curve obtained using a dynamic viscoelasticity measuring apparatus according to JIS K 7244-4 has a second loss modulus peak that is convex-shaped in a direction inverse to the first loss modulus peak, in a temperature region of 100° C. or higher.

Configuration (c″): A heat shrinkage ratio in a main shrinkage direction obtained when the heat-shrinkable polyester film is immersed in hot water at 80° C. for 10 seconds is 30% or more.

That is, for a heat-shrinkable polyester film derived from a predetermined blend composition, when a loss modulus curve obtained using a dynamic viscoelasticity measuring apparatus (DMA) has a first loss modulus peak and a second loss modulus peak each in a different temperature region, the balance between a glassy region and a rubber elastic region is improved, the heat shrinkage ratio at a predetermined temperature could be precisely controlled, and furthermore, the wrinkle resistance characteristics could be improved.

### BRIEF DESCRIPTION OF DRAWINGS

FIGS. 1A to 1C are each a drawing for describing the morphology of a heat-shrinkable polyester film;

FIGS. 2A to 2C are each a drawing for describing the storage modulus curve, the loss modulus curve, and the loss coefficient curve obtained using a dynamic viscoelasticity measuring apparatus for a heat-shrinkable polyester film (Examples 1 to 3);

FIGS. 3A to 3C are each a drawing for describing the storage modulus curve, the loss modulus curve, and the loss coefficient curve obtained using a dynamic viscoelasticity measuring apparatus for a heat-shrinkable polyester film (Examples 4 to 6);

FIGS. 4A to 4C are each a drawing for describing the storage modulus curve, the loss modulus curve, and the loss coefficient curve obtained using a dynamic viscoelasticity measuring apparatus for a heat-shrinkable polyester film (Examples 7 and 8 and Comparative Example 1);

FIGS. 5A to 5D are drawings provided to describe the relation between the blending amounts of an amorphous polyester resin/a crystalline polyester resin, and the temperature of a first peak as well as the temperature of a second peak in the loss coefficient curve;

FIGS. 6A to 6D are drawings provided to describe the relation between the blending amounts of the amorphous polyester resin/crystalline polyester resin and the height of the first peak/height of the second peak in the loss coefficient curve;

FIGS. 7A to 7D are drawings (photographs) describing the state of external appearance of a cylindrical-shaped label according to Example 1, in a case where no wrinkles have occurred, and FIGS. 7B to 7D are enlarged views of regions P, Q, and R, respectively, of the external appearance shown in FIG. 7A; and

FIG. 8A is a drawing (photograph) describing the state of external appearance of a cylindrical-shaped label according to Comparative Example 1, in a case where no wrinkles have occurred, and FIGS. 8B to 8D are enlarged views of regions S, T, and U, respectively, of the external appearance shown in FIG. 8A.

### BEST MODE(S) FOR CARRYING OUT THE INVENTION

### First Embodiment

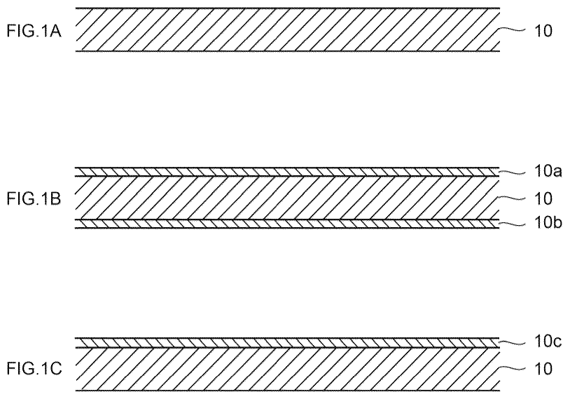

A first embodiment is a heat-shrinkable polyester film 10 shown as an example in FIG. 1A and the like, which is a heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a) to (c).

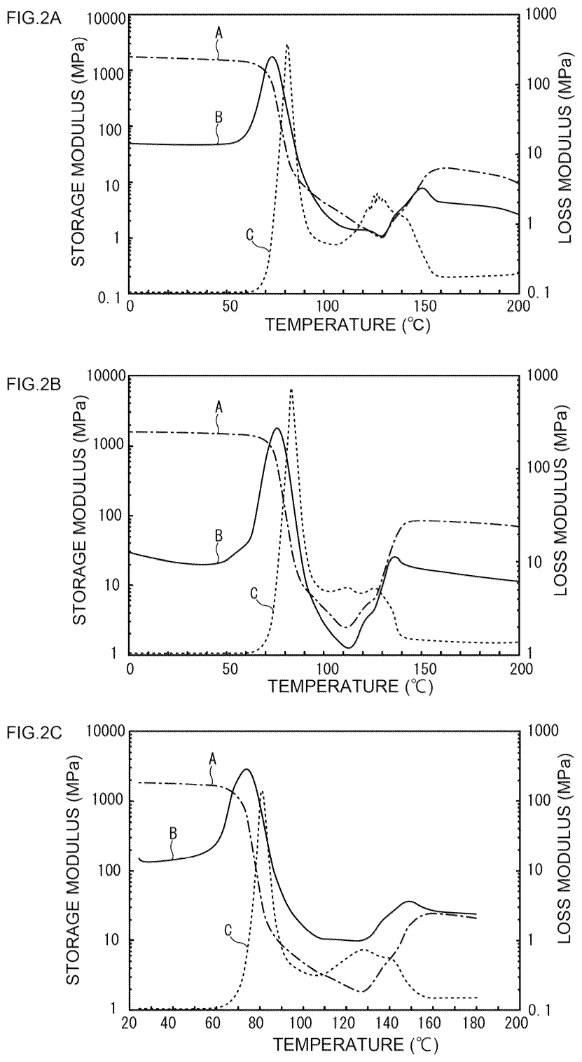

Configuration (a): According to JIS K 7244-4, as shown in FIG. 2A to FIG. 4B, the loss coefficient obtained using a dynamic viscoelasticity measuring apparatus has a first loss coefficient peak in a temperature region of below 100° C.

Configuration (b): According to JIS K 7244-4, as shown in FIG. 2A to FIG. 4B, the loss coefficient obtained using a dynamic viscoelasticity measuring apparatus has a second loss coefficient peak in a temperature region of 100° C. or higher.

Configuration (c): The heat shrinkage ratio in the main shrinkage direction obtained when the heat-shrinkable polyester film is immersed in hot water at 80° C. for 10 seconds is 30% or more.

Hereinafter, the configuration and the like of the heat-shrinkable polyester film of the first embodiment will be specifically described in divided sections, with reference to the drawings as appropriate.

### 1. Polyester Resin

The polyester resin constituting the heat-shrinkable polyester film of the first embodiment is derived from a polyester resin composition containing 30% to 90% by weight of an amorphous polyester resin and 10% to 70% by weight of a crystalline polyester resin.

### (1) Amorphous Polyester Resin

As the amorphous polyester resin, basically, any polyester resin which is a polymer derived from a polyalcohol and a dicarboxylic acid and is in an amorphous state at room temperature, can be used.

Therefore, the amorphous polyester resin is preferably an amorphous polyester resin formed from a polyalcohol and a hydroxycarboxylic acid, an amorphous polyester resin formed from a polyalcohol dicarboxylic acid and a hydroxycarboxylic acid, or a mixture of these polyester resins.

Whether a polyester resin falls under the category of amorphous polyester resin can be determined from the fact that a melting peak of a crystalline portion does not basically appear in a DSC curve obtained using a DSC (differential scanning calorimeter).

Here, the polyalcohol as a raw material component of the amorphous polyester resin may be at least one diol of an aliphatic diol such as ethylene glycol, diethylene glycol, propanediol, butanediol, neopentyl glycol, or hexanediol; an alicyclic diol such as 1, 4-hexanedimethanol; an aromatic diol; and the like.

Therefore, among these polyalcohols, ethylene glycol, diethylene glycol, and 1,4-heaxnedimethanol in particular are preferred.

It is because, by using such a polyalcohol, the polyalcohol may be appropriately reacted with a polyvalent carboxylic acid, and an amorphous polyester resin in which amorphousness is controlled in a desired state is likely to be obtained.

Furthermore, the dicarboxylic acid as a raw material component of the same polyester resin may be at least one of a fatty acid dicarboxylic acid such as adipic acid, sebacic acid, or azelaic acid; an aromatic dicarboxylic acid such as terephthalic acid, naphthalenedicarboxylic acid, or isophthalic acid; an alicyclic dicarboxylic acid such as 1,4-cyclohexanedicarboxylic acid; ester-forming derivatives of these; and the like.

Among these, terephthalic acid in particular is preferred.

Furthermore, the hydroxycarboxylic acid as a compound component of the same polyester resin may be at least one of lactic acid, hydroxybutyric acid, polycaprolactone, and the like.

Accordingly, examples of the amorphous polyester resin include amorphous polyethylene terephthalate, amorphous polyethylene naphthalate, amorphous polybutylene terephthalate, amorphous polybutylene naphthalate, and amorphous polypropylene terephthalate, and these may be used singly or as mixtures.

Particularly, as an example of the amorphous polyester resin, an amorphous polyester resin formed from 50 to 80 parts by weight of ethylene glycol, 5 to 20 parts by weight of diethylene glycol, and 20 to 50 parts by weight of 1,4-cyclohexanedimethanol or neopentyl glycol with respect to 100 parts by weight of terephthalic acid in the total amount of reactive components could be suitably used.

Furthermore, if necessary, other dicarboxylic acids and diols, or hydroxycarboxylic acids may also be used in order to modify the property and characteristics of the heat-shrinkable film.

### (2) Crystalline Polyester Resin

On the other hand, basically, any polyester resin having a crystalline portion at room temperature could be used as the crystalline polyester resin.

Therefore, the crystalline polyester resin is preferably a polyester resin formed from a polyalcohol and a dicarboxylic acid, a polyester resin formed from a polyalcohol and a hydroxycarboxylic acid, a polyester resin formed from a polyalcohol dicarboxylic acid and a hydroxycarboxylic acid, or a mixture of these polyester resins.

Whether a polyester resin falls under the category of the crystalline polyester resin could be determined by the fact that a melting peak of a crystalline portion basically appears in a predetermined temperature region in a DSC curve obtained using a DSC (differential scanning calorimeter).

Here, the polyalcohol as a compound component of the polyester resin may be at least one diol of an aliphatic diol such as ethylene glycol, diethylene glycol, propanediol, butanediol, neopentyl glycol, or hexanediol; an alicyclic diol such as 1,4-hexanedimethanol; an aromatic diol; and the like, which are similar to the reactive components of the amorphous polyester resin.

Among these, ethylene glycol, diethylene glycol, and 1, 4-hexanedimethanol in particular are preferred.

Furthermore, the dicarboxylic acid as a reactive component of the same polyester resin may be at least one of a fatty acid dicarboxylic acid such as adipic acid, sebacic acid, or azelaic acid; an aromatic dicarboxylic acid such as terephthalic acid, naphthalenedicarboxylic acid, or isophthalic acid; an alicyclic dicarboxylic acid such as 1, 4-cyclohexanedicarboxylic acid; ester-forming derivatives of these; and the like.

Therefore, examples of the crystalline polyester resin include polyethylene terephthalate, polyethylene naphthalate, polybutylene terephthalate, polybutylene naphthalate, and polypropylene terephthalate, and these may be used singly or as mixtures.

In particular, as an example of the crystalline polyester resin, a crystalline polyester resin formed from 100 parts by weight of ethylene glycol with respect to 100 parts by weight of terephthalic acid in the total amount of the reactive components could be suitably used.

Furthermore, as an example of the crystalline polyester resin, a crystalline polyester resin formed from 90 to 99 parts by weight of ethylene glycol, 0.5 to 5 parts by weight of isopropanol, and 1 to 10 parts by weight of diethylene glycol with respect to 90 to 99 parts by weight of terephthalic acid in the total amount (100 parts by weight) of the reactive components could be suitably used.

### (3) Blending Ratio

The polyester resin composition constituting the heat-shrinkable polyester film contains 20% to 90% by weight of an amorphous polyester resin and 10% to 80% by weight of a crystalline polyester resin with respect to the total amount (100% by weight).

The reason for this is that, by limiting the blending amounts of the amorphous polyester resin and the crystalline polyester resin in this way, the resins would be uniformly mixed while partial phase separation occurs, and thus it would be difficult to adjust the viscoelastic characteristics such as the loss coefficient.

Therefore, the heat shrinkage ratio and the maximum shrinkage stress near the shrinkage temperature could be more easily adjusted to desired ranges, and at the same time, it is easy to control the haze value and the like quantitatively.

More specifically, it is because when the content of the amorphous polyester resin has a value of below 20% by weight or a value of above 90% by weight, it is difficult to adjust the viscoelastic characteristics such as the loss coefficient, and it would be difficult to control the heat shrinkage ratio and the mechanical strength near the shrinkage temperature of the heat-shrinkable polyester film, or the maximum shrinkage stress and the like.

Therefore, it is more preferable that the polyester resin composition contains 25% to 85% by weight of an amorphous polyester resin and 15% to 75% by weight of a crystalline polyester, and it is even more preferable that the polyester resin composition contains 30% to 80% by weight of an amorphous polyester resin and 20% to 70% by weight of a crystalline polyester resin, all with respect to the total amount.

### 2. Configuration (a)

As the configuration (a), according to JIS K 7244-4, as shown in FIG. 2A to FIG. 4B, the loss coefficient (tan δ) obtained using a dynamic viscoelasticity measuring apparatus has a first loss coefficient peak in a temperature region of below 100° C.

The reason for this is that, although it is also related to the configuration (b) and the like that will be described below, for the heat-shrinkable polyester film derived from a predetermined blend composition, as the loss coefficient obtained using a dynamic viscoelasticity measuring apparatus has a first loss coefficient peak in a predetermined temperature region, the heat shrinkage ratio at a predetermined temperature could be precisely controlled, and furthermore, the wrinkle resistance characteristics could be improved.

Further, it is more preferable that the temperature region in which such a first loss coefficient peak appears is below 100° C., and usually has a value within the range of 80° C. to below 98° C.

The reason for this is that, by controlling the peak temperature of the loss coefficient obtained in a temperature region of below 100° C. in the loss coefficient curve to a value within a predetermined range, it would be difficult to adjust the viscoelastic characteristics such as the loss coefficient, and it would be easy to control the heat shrinkage ratio and the mechanical strength near the shrinkage temperature of the heat-shrinkable polyester film, or the maximum shrinkage stress and the like.

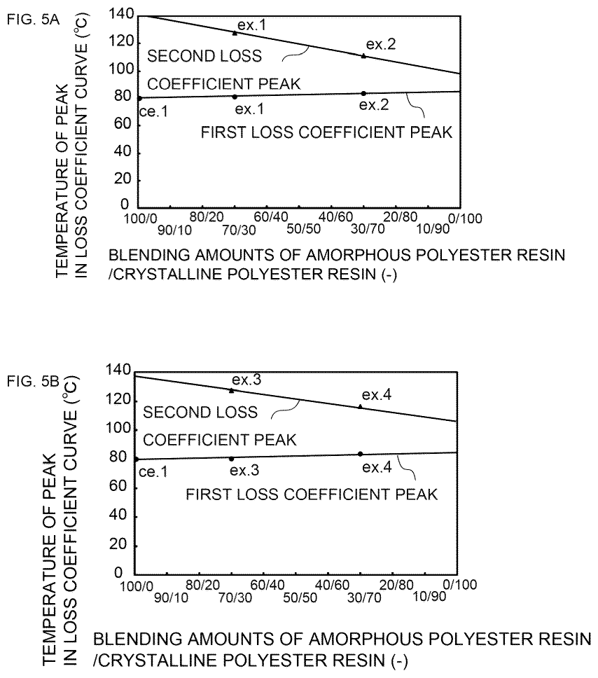

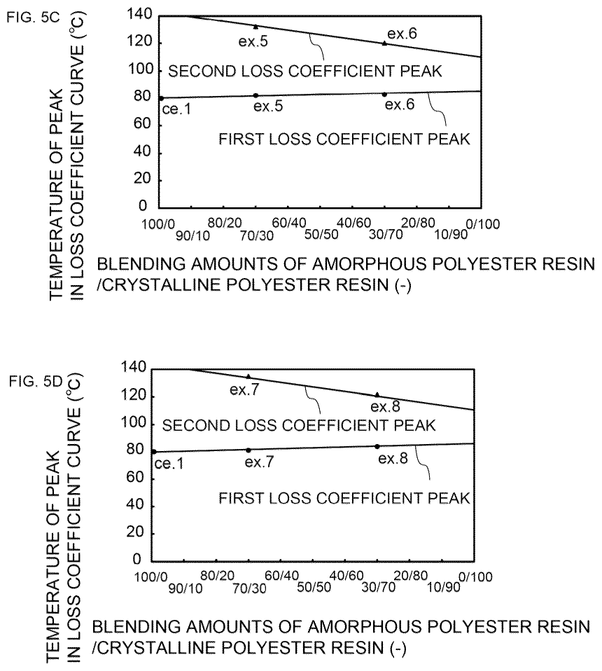

Here, referring to FIGS. 5A to 5D, the relation between the blending amounts of the amorphous polyester resin/crystalline polyester resin and the temperatures of the first loss coefficient peak and the second loss coefficient peak will be described.

That is, the axis of abscissa in FIGS. 5A to 5D represents the blending amounts of the amorphous polyester resin/crystalline polyester resin, and the axis of ordinate represents the temperatures of the first loss coefficient peak and the second loss coefficient peak.

As understood from the characteristic curve in FIGS. 5A to 5D, there is a high correlation between the blending amounts of the amorphous polyester resin/crystalline polyester resin and each of the temperature of the first loss coefficient peak and the temperature of the second loss coefficient peak.

Therefore, it is understood that although it depends on the types and the like of the amorphous polyester resin and the crystalline polyester resin, the temperature of the first loss coefficient peak and the temperature of the second loss coefficient peak could be each controlled by controlling the blending amounts of these resins.

Furthermore, it is more preferable that the height of the first loss coefficient peak obtained by such a loss coefficient usually has a value within the range of 1.5 to 2.5.

That is, it is because, in the loss coefficient curve, when the height of the first loss coefficient peak has a value of below 1.5, the balance of the blending amounts of the amorphous polyester resin and the crystalline polyester resin, and the state of mixing would be deteriorated, it would be difficult to adjust the viscoelastic characteristics such as the loss coefficient, and it would be easy to control the heat shrinkage ratio and the mechanical strength near the shrinkage temperature of the heat-shrinkable polyester film, or the maximum shrinkage stress and the like.

Therefore, it is more preferable that the height of the first loss coefficient peak obtained by the loss coefficient has a value within the range of 1.7 to 2.3, and even more preferably a value within the range of 1.8 to 2.0.

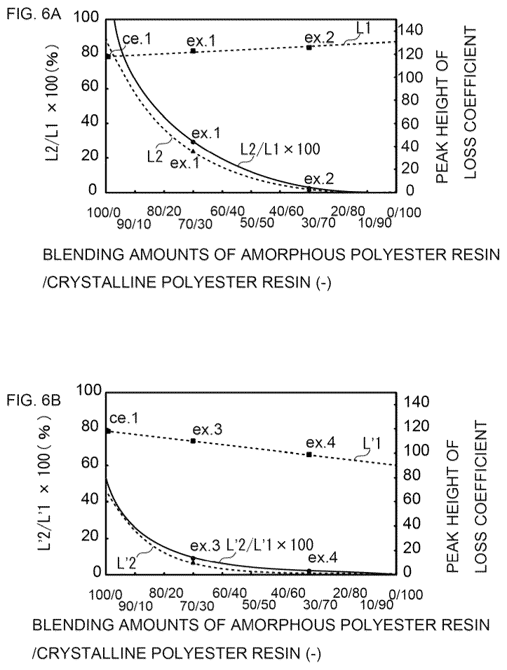

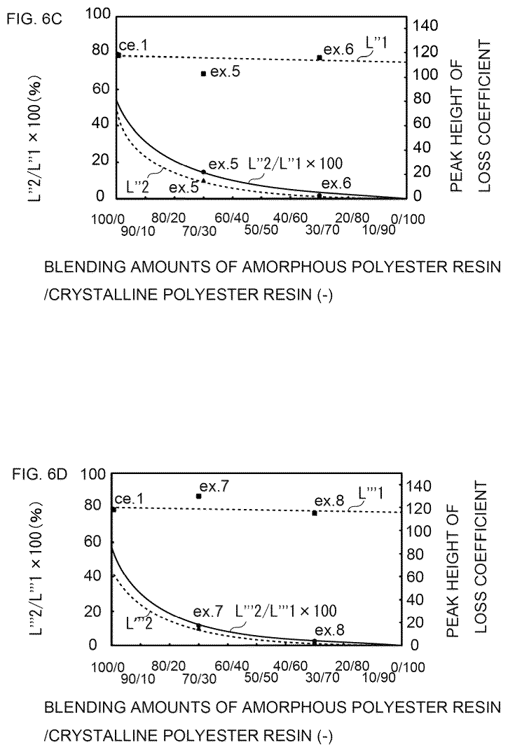

Furthermore, referring to FIGS. 6A to 6D, the relation between the blending amounts of the amorphous polyester resin/crystalline polyester resin and the ratio of height of first loss coefficient peak/height of second loss coefficient peak in the loss coefficient curve will be described.

Here, referring to FIGS. 6A to 6D, the relation between the blending amounts of the amorphous polyester resin/crystalline polyester resin and the temperature of the first peak and the temperature of the second peak in the loss coefficient curve will be described.

That is, the axis of abscissa in FIGS. 6A to 6D represents the blending amounts of the amorphous polyester resin/crystalline polyester resin, and the axis of ordinate represents the ratio of the height of the first loss coefficient peak and the height of the second loss coefficient peak in the loss coefficient curve.

As is understood from the characteristic curve in FIGS. 6A to 6D, there is a high correlation between the blending amounts of the amorphous polyester resin/crystalline polyester resin and the ratio of height of first loss coefficient peak/height of second loss coefficient peak in the loss coefficient curve.

Therefore, it is understood that, although it depends on the types and the like of the amorphous polyester resin and the crystalline polyester resin, the ratio of height of first loss coefficient peak/height of second loss coefficient peak in the loss coefficient curve, as well as the single peak heights of the peaks could also be each controlled by controlling the blending amounts of these resins.

With regard to the first loss coefficient peak obtained by dynamic viscoelasticity measurement, it is preferable that the difference between the first loss coefficient peak temperature and the temperature at which a first deflection point where the storage modulus decreases appears in the storage modulus curve, is 5° C. or higher.

The reason for this is that by controlling the first loss coefficient peak temperature to a value within a predetermined range in the storage modulus curve in consideration of the first deflection point temperature, the blending proportions of the amorphous polyester resin/crystalline polyester resin is controlled within a predetermined range and in a well-balanced manner.

That is, by taking into consideration the difference between the first loss coefficient peak temperature and the temperature at which the first deflection point in the storage modulus curve appears, not only is the mixing dispersibility of the amorphous polyester resin/crystalline polyester resin improved while partial phase separation occurs, but it is also easier to adjust the heat shrinkage ratio and the like.

Therefore, it is more preferable that the difference between the first loss coefficient peak temperature of such a loss coefficient and the first inflection point temperature of the storage modulus is within the range of 8° C. to 18° C., and even more preferably within the range of 10° C. to 15° C.

### 3. Configuration (b)

As the configuration (b), according to JIS K 7244-4, the loss coefficient obtained using a dynamic viscoelasticity measuring apparatus has a second loss coefficient peak in a temperature region of 100° C. or higher, as shown in FIG. 2A to FIG. 4B.

The reason for this is that, although it is also related to the above-mentioned configuration (a) and the like, for the heat-shrinkable polyester film derived from a predetermined blending composition, as the loss coefficient obtained using a dynamic viscoelasticity measuring apparatus has a second loss coefficient peak in a predetermined temperature region, the heat shrinkage ratio at a predetermined temperature could be precisely controlled, and furthermore, the wrinkle resistance characteristics could be improved.

Then, the temperature region in which such a second loss coefficient peak appears is a temperature region of 100° C. or higher, and usually, it is preferable that the temperature region has a value within the range of 110° C. to 150° C., and even more preferably a value within the range of 120° C. to 130° C.

The reason for this is that, by controlling the temperature region in which such a second loss coefficient peak appears, it would be easy to adjust the viscoelastic characteristics such as loss coefficient, and it would be easy to control the heat shrinkage ratio and the mechanical strength near the shrinkage temperature of the heat-shrinkable polyester film, or the maximum shrinkage stress and the like.

Furthermore, it is more preferable that the height of such a second loss coefficient peak usually has a value within the range of 0.2 to 1.

That is, it is because, in the loss coefficient curve, when the height of the first loss coefficient peak has a value of below 0.2 or above 1, the balance of the blending amounts of the amorphous polyester resin and the crystalline polyester resin and the state of mixing would be deteriorated.

Accordingly, it is because it would be difficult to adjust the viscoelastic characteristics such as the loss coefficient, and it would be easy to control the heat shrinkage ratio and the mechanical strength near the shrinkage temperature of the heat-shrinkable polyester film, or the maximum shrinkage ratio.

Therefore, it is more preferable that the height of the first loss coefficient peak obtained by the loss coefficient has a value within the range of 0.3 to 0.8, and even more preferably a value within the range of 0.5 to 0.6.

Furthermore, it is more preferable that the height of such a second loss coefficient peak is determined in consideration of the height of the first loss coefficient peak.

That is, it is preferable that when the height of the first loss coefficient peak is 100, the height of the second loss coefficient peak has a value within the range of 20 to 50.

The reason for this is that, by controlling the ratio of the height of the first loss coefficient peak/height of the second loss coefficient peak in this way, the balance of the blending amounts of the amorphous polyester resin and the crystalline polyester resin, and the state of mixing are improved, and it is easier to adjust the heat shrinkage ratio in a wide temperature range and to adjust mechanical characteristics and durability.

Therefore, when the height of the first loss coefficient peak is 100, it is more preferable that the height of the second loss coefficient peak has a value within the range of 25 to 45, and even more preferably a value within the range of 20 to 40.

### 4. Configuration (c)

As the configuration (c), the heat shrinkage ratio in the main shrinkage direction (TD direction) obtained when the heat-shrinkable polyester film is immersed in hot water at 80° C. for 10 seconds is 30% or more.

The reason for this is that, when a desired heat shrinkage ratio is easily obtained at 80° C., which is generally used under such heat shrinkage temperature conditions, the heat shrinkage ratio in a wide temperature range could be precisely controlled, and furthermore, the wrinkle resistance characteristics could be improved.

Therefore, it is because the wrinkle resistance characteristics of the heat-shrinkable polyester film could be improved, and adjustment of the mechanical characteristics, heat shrinkage ratio, and the like could be easily carried out.

Incidentally, it is preferable that the heat shrinkage ratio in the main shrinkage direction obtained when the heat-shrinkable polyester film is immersed in hot water at 80° C. for 10 seconds has a value within the range of 35% to 55%, and even more preferably a value within the range of 38% to 50%.

### 5. Configuration (d)

As a configuration (d), it is preferable that in a storage modulus curve obtained by dynamic viscoelasticity measurement, the storage modulus at 80° C. has a value within the range of 40 MPa to 300 MPa.

The reason for this is that, by controlling the storage modulus in a predetermined temperature region in the storage modulus curve to a specific range, it is easier to recognize a deflection point (first deflection point).

Therefore, even in a case where there is manufacturing variation or the like, the inflection point of the storage modulus in a predetermined temperature region can be controlled, and the wrinkle resistance characteristics can be improved in a more stable manner.

Therefore, it is more preferable that the storage modulus at 80° C. in the storage modulus curve has a value within the range of 50 MPa to 200 MPa, and even more preferably a value within the range of 60 MPa to 150 MPa.

### 6. Configuration (e)

As a configuration (e), it is preferable that the absolute value of the difference (IV1−IV2) between the intrinsic viscosity of the amorphous polyester resin (sometimes referred to as IV1) and the intrinsic viscosity of the crystalline polyester resin (sometimes referred to as IV2) is 0.5 or less.

It is because, by controlling the absolute value of the difference between the intrinsic viscosity of the amorphous polyester resin and the intrinsic viscosity of the crystalline polyester resin to a value within a predetermined range in this way, it is easy to control the blending proportions of the amorphous polyester resin/crystalline polyester resin to predetermined ranges, and it is easier to adjust the heat shrinkage ratio.

In addition, when the difference between these intrinsic viscosities is limited, the mechanical characteristics and durability can be further stabilized.

Therefore, it is more preferable that the absolute value of the difference (IV1−IV2) between the intrinsic viscosity (IV1) of the amorphous polyester resin and the intrinsic viscosity (IV2) of the crystalline polyester resin has a value within the range of 0.001 to 0.1, and even more preferably a value within the range of 0.01 to 0.08.

Furthermore, it is preferable that the intrinsic viscosity of the amorphous polyester resin has a value within the range of 0.6 to 0.85 dL/g.

Although it is also related to the intrinsic viscosity of the crystalline polyester resin that will be described below, by setting the intrinsic viscosity of the amorphous polyester resin to a value within a predetermined range in this way, not only is the mixing dispersibility improved between the amorphous polyester resin and the crystalline polyester resin while partial phase separation occurs, but it is also easy to adjust the heat shrinkage ratio in a wide temperature range and to adjust mechanical characteristics and durability.

Therefore, it is more preferable that the intrinsic viscosity of the amorphous polyester resin has a value within the range of 0.65 to 0.83 dL/g, and even more preferably a value within the range of 0.7 to 0.8 dL/g.

Furthermore, it is preferable that the intrinsic viscosity of the crystalline polyester resin has a value within the range of 0.6 to 0.85 dL/g.

Although it is also related to the intrinsic viscosity of the above-described crystalline polyester resin, by setting the intrinsic viscosity of the amorphous polyester resin to a value within a predetermined range in this way, not only is the mixing dispersibility improved between the crystalline polyester resin and the amorphous polyester resin while partial phase separation occurs, but it is also easy to adjust the heat shrinkage ratio in a wide temperature range and to adjust mechanical characteristics and durability.

Therefore, it is more preferable that the intrinsic viscosity of the crystalline polyester resin has a value within the range of 0.65 to 0.83 dL/g, and even more preferably a value within the range of 0.7 to 0.8 dL/g.

### 7. Thickness

It is preferable that the thickness of the heat-shrinkable polyester film usually has a value within the range of 10 to 200 μm.

The reason for this is that, by specifically limiting the film thickness before heat shrinkage to a value within a predetermined range in this way, it is easy to produce the film to a uniform thickness, it is also easy to control the heat shrinkage ratio and to control the maximum shrinkage stress, and it is easy to prevent the occurrence of shrinkage unevenness.

Therefore, it is more preferable that the film thickness before heat shrinkage has a value within the range of 20 to 100 μm, and even more preferably a value within the range of 30 to 50 μm.

### 8. Thermal Characteristics and the Like of Heat-Shrinkable Polyester Film

### (1) Heat Shrinkage Ratio 1 in TD Direction

It is a configuration requirement to the effect that in the heat-shrinkable polyester film, the main shrinkage direction is the TD direction, and the heat shrinkage ratio (A2) in the TD direction when the film is caused to shrink under the conditions of a temperature of 90° C. and 10 seconds has a value of 40% to below 80%.

The reason for this is that, by limiting such a 90° C. heat shrinkage ratio to 40% to below 80%, in the heat-shrinkable polyester film during heat shrinkage, a satisfactory heat shrinkage ratio is obtained, and furthermore, the maximum shrinkage stress is also easily obtained.

Therefore, it is more preferable that the 90° C. heat shrinkage ratio in the TD direction has a value within the range of 42% to below 75%, and even more preferably a value within the range of 45% to 70%.

### (2) Heat Shrinkage Ratio 2 in TD Direction

It is a configuration requirement to the effect that in the heat-shrinkable polyester film, the heat shrinkage ratio (A3) in the TD direction in a case where the film is caused to shrink under the conditions of a temperature of 70° C. and 10 seconds has a value of below 25%.

The reason for this is that, by limiting such a 70° C. heat shrinkage ratio, in the heat-shrinkable polyester film during heat shrinkage, a satisfactory heat shrinkage ratio is obtained, and furthermore, the maximum shrinkage stress is also easily obtained.

Therefore, it is more preferable that the 70° C. heat shrinkage ratio in the TD direction has a value within the range of 5% to 23%, and even more preferably a value within the range of 10% to 20%.

### (3) Heat Shrinkage Ratio 3 in MD Direction

It is a configuration requirement to the effect that in the heat-shrinkable polyester film, a direction orthogonally intersecting the main shrinkage direction is designated as MD direction, and the heat shrinkage ratio (B1) in the MD direction in a case where the film is caused to shrink under the conditions of a temperature of 80° C. and 10 seconds has a value of 5% or less.

The reason for this is that, by limiting such an 80° C. heat shrinkage ratio in the MD direction to a value of 5% or less, in the heat-shrinkable polyester film during heat shrinkage, a satisfactory heat shrinkage ratio is obtained in the main heat shrinkage direction, and furthermore, the maximum shrinkage stress is easily obtained.

Therefore, it is more preferable that such an 80° C. heat shrinkage ratio in the MD direction has a value within the range of 3% or less, and even more preferably a value of 1% or less.

### (4) Heat Shrinkage Ratio 4 in MD Direction

It is a configuration requirement to the effect that in the heat-shrinkable polyester film, a direction orthogonally intersecting the main shrinkage direction is MD direction, and the heat shrinkage ratio (B2) in the MD direction in a case where the film is caused to shrink under the conditions of a temperature of 90° C. and 10 seconds has a value of 10% or less.

The reason for this is that, by limiting such a 90° C. heat shrinkage ratio in the MD direction to a value of 10% or less, in the heat-shrinkable polyester film during heat shrinkage, a satisfactory heat shrinkage ratio is obtained, and furthermore, the maximum shrinkage stress is easily obtained.

Therefore, it is more preferable that such a 90° C. heat shrinkage ratio in the MD direction has a value of 8% or less, and even more preferably a value of 5% or less.

### (5) Stretch Ratio in MD Direction

It is preferable that the stretch ratio in the MD direction (average MD direction stretch ratio, may be simply referred to as MD direction stretch ratio) of the heat-shrinkable polyester film has a value within the range of 100% to 200%.

The reason for this is that, by specifically limiting the stretch ratio in the MD direction to a value within a predetermined range in this way, and by specifically limiting each of a predetermined heat shrinkage ratio, a standard deviation thereof, and the like to a value within a predetermined range, the occurrence of fine wrinkles can be further suppressed.

Therefore, it is more preferable that the MD direction stretch ratio has a value within the range of 105% to 180%, and even more preferably a value within the range of 110% to 160%.

### (6) Stretch Ratio in TD Direction

It is preferable that the stretch ratio configuration in the TD direction (average TD direction stretch ratio, or may be simply referred to as TD direction stretch ratio) has a value within the range of 200% to 600%, more preferably a value within the range of 220% to 550%, and even more preferably a value within the range of 250% to 500%.

The reason for this is that, by specifically limiting the stretch ratio in the TD direction to a value within a predetermined range in this way and specifically limiting each of a predetermined heat shrinkage ratio, a standard deviation thereof, and the like to a value within a predetermined range, the occurrence of fine wrinkles can be further suppressed.

### (7) Haze Value

It is preferable that the haze value of the heat-shrinkable polyester film before heat shrinkage, which is measured according to JIS K 7105, has a value of 5% or less.

The reason for this is that, by specifically limiting the haze value to a value within a predetermined range in this way, transparency of the heat-shrinkable polyester film is also easily controlled quantitatively, and since transparency is satisfactory, general-purpose usability can be further enhanced.

More specifically, it is because when the haze value of the film before heat shrinkage has a value of above 5%, transparency would decrease, and it would be difficult to apply the film to decorative applications and the like for PET bottles.

On the other hand, it is because when the haze value of the film before heat shrinkage becomes excessively small, it would be difficult to control the haze value in a stable manner, and the production yield would decrease significantly.

Therefore, as a configuration (g), it is more preferable that the haze value of the film before heat shrinkage has a value within the range of 0.1% to 3%, and even more preferably a value within the range of 0.5% to 1%.

### (8) Configuration of Heat-Shrinkable Polyester Film

It is preferable that various additives are blended into the heat-shrinkable polyester film, or those additives are attached onto one surface or both surfaces of the film.

More specifically, it is preferable that at least one of a hydrolysis preventing agent, an antistatic agent, an ultraviolet absorber, an infrared absorber, a colorant, an organic filler, an inorganic filler, an organic fiber, an inorganic fiber, and the like is blended usually in an amount within the range of 0.01% to 10% by weight, and more preferably within the range of 0.1% to 1% by weight, with respect to the total amount of the heat-shrinkable polyester film.

Furthermore, as shown in FIG. 1B, it is also preferable that other resin layers 10a and 10b each containing at least one of these various additives are laminated on one surface or both surfaces of the heat-shrinkable polyester film 10.

In that case, it is preferable that when the thickness of the heat-shrinkable polyester film is taken as 100%, the single layer thickness or the total thickness of the other resin layers that are additionally laminated usually has a value within the range of 0.1% to 10%.

Then, the resin as a main component constituting the other resin layers may be the same polyester resin as that of the heat-shrinkable polyester film, or the resin is preferably at least one of an acrylic resin different from the polyester resin, an olefin resin, a urethane resin, a rubber resin, and the like.

Furthermore, it is also preferable that the heat-shrinkable polyester film is made to have a multilayer structure to further promote a hydrolysis preventive effect and mechanical protection, or as shown in FIG. 1C, a shrinkage ratio adjusting layer 10c is provided on the surface of the heat-shrinkable polyester film 10 so that the shrinkage ratio of the heat-shrinkable polyester film becomes uniform within the plane.

Such a shrinkage ratio adjusting layer can be laminated by using an adhesive, an application method, a heating treatment, or the like, depending on the shrinkage characteristics of the heat-shrinkable polyester film.

More specifically, the thickness of the shrinkage ratio adjusting layer is within the range of 0.1 to 3 μm, and in a case where the shrinkage ratio of the heat-shrinkable polyester film at a predetermined temperature is excessively large, it is preferable to laminate a shrinkage ratio adjusting layer of a type that decreases the shrinkage ratio.

Furthermore, in a case where the shrinkage ratio of the heat-shrinkable polyester film at a predetermined temperature is excessively small, it is preferable to laminate a shrinkage ratio adjusting layer of a type that increases the shrinkage ratio.

Therefore, it is intended to obtain a desired shrinkage ratio for the heat-shrinkable polyester film by using a shrinkage ratio adjusting layer, without producing various heat-shrinkable films having different shrinkage ratios.

### Second Embodiment

A second embodiment is a heat-shrinkable polyester film 10 shown as an example in FIG. 1A and the like, which is a heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a′) to (c′).

Configuration (a′): According to JIS K 7244-4, as shown in FIG. 2A to FIG. 4B, a storage modulus curve obtained using a dynamic viscoelasticity measuring apparatus has a descending deflection point in a temperature region of below 100° C.

Configuration (b′): According to JIS K 7244-4, as shown in FIG. 2A to FIG. 4B, a storage modulus curve obtained using a dynamic viscoelasticity measuring apparatus has an ascending deflection point in a temperature region of 100° C. or higher.

Configuration (c′): A heat shrinkage ratio in a main shrinkage direction obtained when the film is immersed in hot water at 80° C. for 10 seconds is 30% or more.

That is, for a heat-shrinkable polyester film derived from a predetermined blend composition, as a storage modulus curve obtained using a dynamic viscoelasticity measuring apparatus (DMA) has a first deflection point (descending deflection point) and a second deflection point (ascending deflection point) each in a different temperature region, the balance between a glassy region and a rubber elastic region is improved, the heat shrinkage ratio at a predetermined temperature can be precisely controlled, and furthermore, wrinkle resistance characteristics can be improved.

Incidentally, the types and blending amounts of the amorphous polyester resin and the crystalline polyester resin constituting the second embodiment, other heat shrinkage ratios, configurations of the heat-shrinkable film, and the like can be similar to the configurations of the first embodiment.

### Third Embodiment

A third embodiment is a heat-shrinkable polyester film 10 shown as an example in FIG. 1A and the like, which is a heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a″) to (c″).

Configuration (a″): According to JIS K 7244-4, as shown in FIG. 2A to FIG. 4B, a loss modulus curve obtained using a dynamic viscoelasticity measuring apparatus has a first loss coefficient peak in a temperature region of below 100° C.

Configuration (b″): According to JIS K 7244-4, as shown in FIG. 2A to FIG. 4B, a loss modulus curve obtained using a dynamic viscoelasticity measuring apparatus has a second inverse peak that is convex-shaped in a direction inverse to the first loss coefficient peak in a temperature region of 100° C. or higher.

Configuration (c″): A heat shrinkage ratio in a main shrinkage direction obtained when the film is immersed in hot water at 80° C. for 10 seconds is 30% or more.

That is, for a heat-shrinkable polyester film derived from a predetermined blend composition, as a loss modulus curve obtained using a dynamic viscoelasticity measuring apparatus (DMA) has a first loss coefficient peak and a second loss coefficient peak each in a different temperature region, the balance between a glassy region and a rubber elastic region is improved, the heat shrinkage ratio at a predetermined temperature can be precisely controlled, and furthermore, wrinkle resistance characteristics can be improved.

Incidentally, the types and blending amounts of the amorphous polyester resin and the crystalline polyester resin constituting the third embodiment, other heat shrinkage ratios, configurations of the heat-shrinkable film, and the like can be similar to the configurations of the first embodiment.

### Fourth Embodiment

A fourth embodiment is an embodiment related to a method of using the heat-shrinkable polyester film of any one of the first embodiment to the third embodiment.

That is, any known method of using a heat-shrinkable film can all be suitably applied.

For example, when implementing the method of using the heat-shrinkable polyester film, first, the heat-shrinkable polyester film is cut to an appropriate length or width, and at the same time, a long cylindrical-shaped object is formed.

Next, the long cylindrical-shaped object is fed to an automatic label attaching apparatus (shrink labeler), cut to a required length, and fitted onto the outside of a PET bottle or the like filled with contents.

Next, as a heating treatment of the heat-shrinkable polyester film fitted onto the outside of a PET bottle or the like, the heat-shrinkable polyester film is passed through the inside of a hot air tunnel or a steam tunnel at a predetermined temperature.

Then, the heat-shrinkable polyester film is uniformly heated and caused to undergo heat shrinkage, by radiating radiant heat such as infrared radiation provided by these tunnels, or blowing heated steam at about 90° C. from the surroundings.

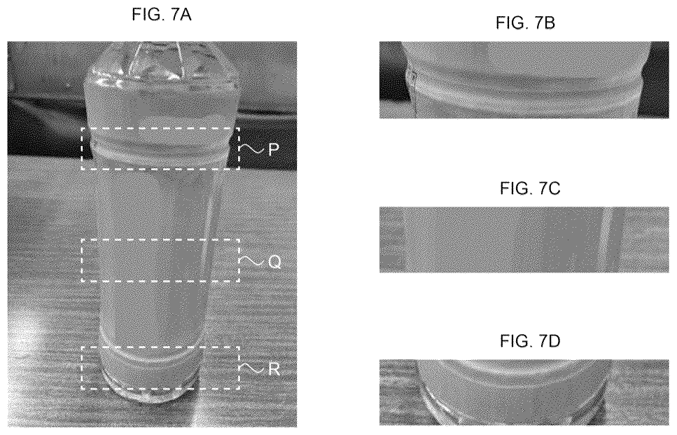

Therefore, when the standard deviation of the heat shrinkage ratio in the TD direction is 20% or less, as shown in FIGS. 7A to 7D, a labeled container can be quickly obtained by adhering the heat-shrinkable polyester film tightly to the outer surface of a PET bottle or the like.

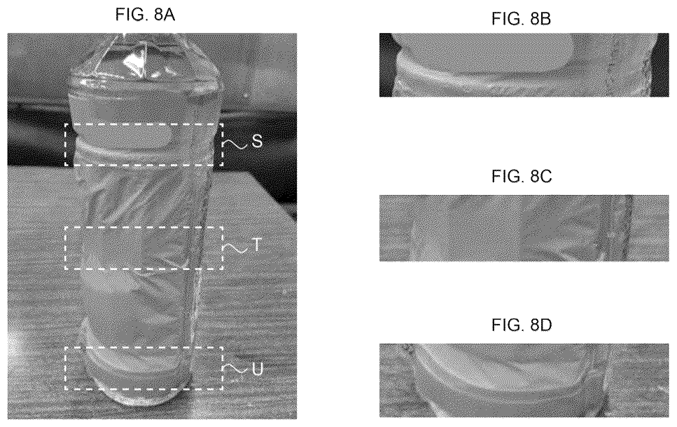

On the other hand, when the standard deviation of the heat shrinkage ratio in the TD direction is above 20%, as shown in FIGS. 8A to 8D, regions where the label could not follow the shape of the bottle periphery occur from the top to the bottom of the bottle body, and the occurrence of wrinkles is also noticeably observed.

### Fifth Embodiment

A fifth embodiment is an embodiment related to a method for manufacturing the heat-shrinkable polyester film of any one of the first embodiment to the third embodiment.

That is, typically, it is preferable to manufacture a predetermined heat-shrinkable polyester film by the following processes.

### 1. Step of Preparing and Mixing Raw Materials

First, it is preferable that main agents and additives such as a crystalline polyester resin, an amorphous polyester resin, a rubber resin, an antistatic agent, and a hydrolysis preventing agent are prepared as raw materials.

Next, it is preferable that the prepared crystalline polyester resin, amorphous polyester resin, and the like are introduced into a stirring container while being weighed, and the materials are mixed and stirred using a stirring device until the mixture becomes uniform.

### 2. Step of Producing Raw Sheet

Next, it is preferable that the uniformly mixed raw materials are dried into an absolute dry state.

Next, typically, it is preferable that extrusion molding is carried out to produce a raw sheet having a predetermined thickness.

More specifically, for example, extrusion molding is carried out under the conditions of an extrusion temperature of 260° C. using an extruder with an L/D ratio of 24 and an extrusion screw diameter of 50 mm (manufactured by Tanabe Plastics Machinery Co., Ltd.), and a raw sheet having a predetermined thickness (usually, 10 to 100 μm) can be obtained.

### 3. Step of Producing Heat-Shrinkable Polyester Film

Next, the obtained raw sheet is heated and pressed while being moved on rolls or between rolls using a heat-shrinkable film manufacturing apparatus, to produce a heat-shrinkable polyester film.

That is, it is preferable that polyester molecules constituting the heat-shrinkable polyester film are crystallized into a predetermined shape by stretching the film in a predetermined direction, while heating and pressing the film at a predetermined stretching temperature and a predetermined stretch ratio while basically expanding the film width.

Then, a heat-shrinkable polyester film that is used for decoration, labeling, and the like of the first embodiment to the third embodiment by thermally fixing the film at a predetermined temperature in that state, can be produced.

### 4. Step of Evaluation Using Dynamic Viscoelasticity Measuring Apparatus

Typically, upon manufacturing the heat-shrinkable polyester film of any one of the first embodiment to the third embodiment, it is preferable that a step of performing evaluation using a dynamic viscoelasticity measuring apparatus (DMA) according to the following order is included.

That is, it is preferable that a predetermined heat-shrinkable polyester film is prepared as an object to be measured, and viscoelastic characteristics such as a storage modulus curve, a loss modulus curve, and a loss coefficient (Tan δ) are measured and evaluated in a predetermined temperature range using a dynamic viscoelasticity measuring apparatus according to JIS K 7244-4.

In that case, it is preferable to check in advance that the thickness of the heat-shrinkable polyester film has a value within a predetermined range.

### 5. Others

The heat-shrinkable polyester film is immersed in hot water in a state of being maintained under the conditions of a predetermined temperature and a predetermined time by using a predetermined heating device, or is heat-treated, to cause the heat-shrinkable polyester film to undergo heat shrinkage, and the heat shrinkage ratio is measured.

Furthermore, it is preferable that the haze value, the glass transition point, or various thermal characteristics of the heat-shrinkable polyester film are measured in advance.

Furthermore, it is preferable that the obtained heat-shrinkable polyester film is fitted on an adherend such as a PET bottle, heat-treated in that state under predetermined conditions, and evaluated for the uniform shrinking property and the like of the heat-shrinkable polyester film.

In addition to that, it is preferable that the following characteristics and the like are measured continuously or intermittently for the produced heat-shrinkable polyester film, and predetermined examination steps are provided.

That is, by measuring the following characteristics and the like through such predetermined examination steps, and checking whether the characteristics and the like have values within predetermined ranges, a heat-shrinkable polyester film having more uniform shrinkage characteristics and the like can be obtained.
1) Examination by visual inspection of the appearance of the heat-shrinkable polyester film
2) Measurement of thickness variation
3) Measurement of haze value
4) Measurement of glass transition point
5) Measurement of melting point and heat of fusion
6) Measurement of tensile modulus
7) Measurement of tear strength
8) Measurement of SS curve

### EXAMPLES

Hereinafter, the present invention will be described in detail based on Examples. However, the scope of rights of the present invention will not be narrowed by the description of Examples without any particular reason.

Incidentally, the polyester resins used in Example 1 and the like are as follows.

### (PETG1)

An amorphous polyester resin composed of dicarboxylic acid: 100 parts by weight (pbw) of terephthalic acid, diol: 63 parts by weight of ethylene glycol, 24 parts by weight of 1, 4-cyclohexanedimethanol, and 13 parts by weight of diethylene glycol (glass transition point: 69.5° C., intrinsic viscosity: 0.78 dL/g)

### (PETG2)

An amorphous polyester resin composed of dicarboxylic acid: 100 parts by weight of terephthalic acid, diol: 59.9 parts by weight of ethylene glycol, 12.4 parts by weight of 1, 4-cyclohexanedimethanol, and 12.4 parts by weight of diethylene glycol (glass transition point: 75° C., intrinsic viscosity: 0.78 dL/g)

### (PETG3)

An amorphous polyester resin composed of dicarboxylic acid: 100 parts by weight of terephthalic acid, diol: 70 parts by weight of ethylene glycol, 28.2 parts by weight of neopentyl glycol, and 12.4 parts by weight of diethylene glycol (glass transition point: 76.5° C., intrinsic viscosity: 0.75 dL/g)

### (APET1)

A crystalline polyester resin composed of dicarboxylic acid: 100 mol % terephthalic acid, and diol: 100 mol % ethylene glycol (glass transition point: none, intrinsic viscosity: 0.65 dL/g)

### (APET2)

A crystalline polyester resin composed of dicarboxylic acid: 100 mol % terephthalic acid, and diol: 100 mol % ethylene glycol (glass transition point: none, intrinsic viscosity: 0.71 dL/g)

### (PCR1)

A recycled crystalline polyester resin composed of dicarboxylic acid: 98.6 parts by weight of terephthalic acid, 1.4 parts by weight of isophthalic acid, diol: 97.3 parts by weight of ethylene glycol, and 2.7 parts by weight of diethylene glycol (glass transition point: none, intrinsic viscosity: 0.72 dL/g)

### (PCR2)

A recycled crystalline polyester resin composed of dicarboxylic acid: 98.6 parts by weight of terephthalic acid, 1.4 parts by weight of isophthalic acid, diol: 97.3 parts by weight of ethylene glycol, and 2.7 parts by weight of diethylene glycol (glass transition point: none, intrinsic viscosity: 0.82 dL/g)

### Example 1

### 1. Production of Heat-Shrinkable Polyester Film

70 parts by weight of an amorphous polyester resin (PETG1) and 30 parts by weight of a crystalline polyester resin (APET1) were held in a stirring container and uniformly mixed and stirred to prepare those as a raw material.

Next, this raw material was dried into an absolute dry state and then subjected to extrusion molding under the condition of an extrusion temperature of 260° C. by using an extruder (manufactured by Tanabe Plastics Machinery Co., Ltd.) with an L/D ratio of 24 and an extrusion screw diameter of 50 mm, to obtain a raw sheet having a thickness of 100μ m.

Next, a heat-shrinkable polyester film having a thickness of 30 μm was produced from the raw sheet by using a heat-shrinkable film manufacturing apparatus, at a preheating temperature of 75° C., a stretching temperature of 75° C., stretch ratios (MD direction: 100%, TD direction: 500%), and a thermal fixing temperature of 60° C.

### 2. Evaluation of Heat-Shrinkable Polyester Film

### (1) Evaluation 1: Thickness Variation

The thickness (taking the desired value 30 μm as a reference value) of the obtained heat-shrinkable polyester film was measured (n=6) by using a micrometer and evaluated according to the following criteria. The results obtained are shown in Table 1 as EVA 1.

⊙ (Very good): The average thickness variation has a value within the range of (reference value±0.1 μm).

◯ (Good): The average thickness variation has a value within the range of (reference value±0.5 μm).

Δ (Fair): The average thickness variation has a value within the range of (reference value±1.0 μm).

X (Bad): The average thickness variation has a value within the range of (reference value±3.0 μm).

(2) Evaluation 2: Heat shrinkage ratio 1 in TD direction

The obtained heat-shrinkable polyester film was immersed in hot water at 80° C. for 10 seconds by using a constant temperature bath to cause the film to undergo heat shrinkage.

Next, the heat shrinkage ratio (A1) was calculated from the dimensional change before and after the heating treatment at a predetermined temperature (hot water at 80° C.) according to the following formula, and was evaluated according to the following criteria. The results obtained are shown in Table 1 as EVA 2.

$$Heat shrinkage ratio = ( Length of film before heat shrinkage - length of film after heat shrinkage ) / length of film before heat shrinkage \times 100$$

⊙ (Very good): The heat shrinkage ratio (A1) has a value within the range of 40% to 50%.

◯ (Good): The heat shrinkage ratio (A1) has a value within the range of 30% to 60% and is outside the range of the above-described ⊙ (Very good).

Δ (Fair): The heat shrinkage ratio (A1) has a value within the range of 20% to 70% and is outside the range of the above-described ◯ (Good).
X (Bad): The heat shrinkage ratio (A1) has a value of below 20% or above 70%.

### (3) Evaluation 3: Heat Shrinkage Ratio 2 in TD Direction

The obtained heat-shrinkable polyester film was immersed in hot water at 90° C. for 10 seconds by using a constant temperature bath to cause the film to undergo heat shrinkage.

Next, the heat shrinkage ratio (A2) was calculated from the dimensional change before and after the heating treatment at a predetermined temperature (hot water at 90° C.) according to the following formula, and was evaluated according to the following criteria. The results obtained are shown in Table 1 as EVA 3.

$$Heat shrinkage ratio = ( Length of film before heat shrinkage - length of film after heat shrinkage ) / length of film before heat shrinkage \times 100$$

⊙ (Very good): The heat shrinkage ratio (A2) has a value within the range of 45% to 70%.

◯ (Good): The heat shrinkage ratio (A2) has a value within the range of 40% to 80% and is outside the range of the above-described ⊙ (Very good).

Δ (Fair): The heat shrinkage ratio (A2) has a value within the range of 35% to 90% and is outside the range of the above-described ◯ (Good).

X (Bad): The heat shrinkage ratio (A2) has a value of below 35% or above 90%.

### (4) Evaluation 4: Intrinsic Viscosity

0.5 g of each polyester resin raw material used in Examples was dissolved in 50 ml of a mixed solvent of phenol/1, 1, 2, 2-tetrachloroethane (weight ratio: 60/40).

Next, the temperature of the mixed solvent was adjusted to 30° C., and the intrinsic viscosity (n) was measured using an Ostwald viscometer, which is shown in Table 1 as EVA 4.

Next, the absolute value of the difference (IV1−IV2) between the intrinsic viscosity (IV1) of the amorphous polyester resin used and the intrinsic viscosity (IV2) of the crystalline polyester resin used was calculated and evaluated according to the following criteria. The results obtained are shown in Table 1 as EVA 4.

⊙ (Very good): The difference in absolute value has a value of 0.05 or less.

◯ (Good): The difference in absolute value has a value of 0.08 or less and is outside the range of the above-described ⊙ (Very good).

Δ (Fair): The difference in absolute value has a value of 0.1 or less and is outside the range of the above-described ◯ (Good).

X (Bad): The difference in absolute value has a value of above 0.1.

### (5) Evaluation 5: Wrinkle Resistance Characteristics

A columnar-shaped PET bottle (volume: 500 ml) in a state of being filled with commercially available drinking water was prepared.

Next, a long heat-shrinkable film was obtained by slitting a heat-shrinkable polyester film to a width of 26 cm, perforations with a width of 1 mm were provided thereon along the longitudinal direction, and 1, 3-dioxolane was applied on the end portions in the width direction.

Next, the end portions in the width direction were overlapped and adhered together such that the overlap margin would be about 1 cm, and a cylindrical-shaped label having a diameter of about 8 cm was obtained. In addition, this cylindrical-shaped label was cut out in the longitudinal direction at an interval of 16 cm, and a plurality of cylindrical-shaped labels were obtained.

Next, the cylindrical-shaped label was placed over the body of the prepared columnar-shaped PET bottle, the columnar-shaped PET bottle was placed on a belt conveyor and moved at a passage speed of 6 m/min through a steam tunnel maintained at 85° C., to cause the cylindrical-shaped label to undergo heat shrinkage such that the cylindrical-shaped label adhered closely from the upper part to the lower part of the body of the columnar-shaped PET bottle.

Next, the cylindrical-shaped label after heat shrinkage was observed by visual inspection, and the wrinkle resistance characteristics were evaluated according to the following criteria, based on whether wrinkles having a predetermined length (1 cm or more) and a predetermined width (1 mm or more) occurred. The results obtained are shown in Table 1 as EVA 5.

⊙ (Very good): The occurrence of predetermined wrinkles was observed in none of five cylindrical-shaped labels.

◯ (Good): No occurrence of predetermined wrinkles was observed in three or more of five cylindrical-shaped labels.

Δ (Fair): No occurrence of predetermined wrinkles was observed in one or more of five cylindrical-shaped labels.

X (Bad): The occurrence of predetermined wrinkles was observed in all of five cylindrical-shaped labels.

### (6) Evaluation 6: Storage Modulus

The obtained heat-shrinkable polyester film was cut out to 15 mm in width×0.05 mm in thickness (cross-sectional area 0.75 mm²) and a sample length (distance between grippers) of 15 mm to prepare a test piece.

Next, the viscoelastic characteristics of the prepared test piece were measured according to JIS K 7244-4 using a dynamic viscoelasticity measuring apparatus (manufactured by TA Instruments, Inc., DMA Q800).

More specifically, during the measurement, while an appropriate static stress (1.4 MPa) was applied by an automatic tension mechanism, the test piece was kept at −30° C. for a while by using liquid nitrogen as a cooling medium.

Thereafter, the test piece was heated at a temperature increase rate of 3° C./min, a sine wave with a displacement amplitude of 15 μm and a frequency of 1 Hz was applied, the storage modulus E′ and the loss modulus E″ were measured as shown in FIG. 2A, and in addition, the loss coefficient (tan δ) was calculated.

Furthermore, in this case, although the upper limit temperature was set to 150° C., the measurement was terminated at the time point when the set static stress could no longer be maintained due to sample elongation.

The storage moduli obtained at 50° C., 70° C., and 80° C. are each shown in Table 2 as EVA 6.

Furthermore, the temperatures of the first deflection point and the second deflection point were calculated from the obtained storage modulus curve, which are each shown in Table 2 as EVA 6.

### (7) Evaluation 7: Loss Modulus

Furthermore, the loss moduli at 50° C., 70° C., and 80° C. obtained by the above-described measurement of dynamic viscoelasticity are each shown in Table 2 as EVA 7.

Furthermore, the temperature of the first loss modulus peak and the temperature of the second loss modulus peak were calculated from the obtained loss modulus curve, which are each shown in Table 2 as EVA 7.

### (8) Evaluation 8: Loss Coefficient

Furthermore, from a storage modulus curve obtained by the above-described dynamic viscoelasticity measurement, the first loss coefficient peak temperature of the loss coefficient (tan δ) was calculated and evaluated according to the following criteria. The results obtained are shown in Table 2 as EVA 8.

⊙ (Very good): The first loss coefficient peak temperature has a value within the range of 78° C. to 90° C.

◯ (Good): The first loss coefficient peak temperature has a value within the range of 75° C. to 93° C. and is a value other than the above-described ⊙ (Very good).

Δ (Fair): The first loss coefficient peak temperature has a value within the range of 70° C. to 95° C. and is a value other than the above-described ◯ (Good).

X (Bad): The first loss coefficient peak temperature has a value of below 70° C. or above 95° C.

Furthermore, similarly, the second loss coefficient peak temperature of the loss coefficient (tan δ) was calculated from the storage modulus curve obtained by the above-described dynamic viscoelasticity measurement and was evaluated according to the following criteria. The results obtained are shown in Table 2 as EVA 8.

⊙ (Very good): The second loss coefficient peak temperature has a value within the range of 120° C. to 130° C.

◯ (Good): The second loss coefficient peak temperature has a value within the range of 115° C. to 135° C. and is a value other than the above-described ⊙ (Very good).

Δ (Fair): The second loss coefficient peak temperature has a value within the range of 110° C. to 140° C. and is a value other than the above-described ◯ (Good).

X (Bad): The first loss coefficient peak temperature has a value of below 110° C. or above 140° C.

### (9) Evaluation 9: Temperature Difference Between Second Deflection Point and First Loss Coefficient Peak

From the second deflection point and the first loss coefficient peak obtained in the above-described dynamic viscoelasticity measurement, the difference between the temperature of the second deflection point and the temperature of the first loss coefficient peak was calculated and evaluated according to the following criteria. The results obtained are shown in Table 2 as EVA 9.

⊙ (Very good): The difference between the temperature of the second deflection point and the temperature of the first loss coefficient peak temperature is 40° C. or more.

◯ (Good): The difference between the temperature of the second deflection point and the temperature of the first loss coefficient peak temperature is 20° C. or more and is outside the range of the above-described ⊙ (Very good).

Δ (Fair): The difference between the temperature of the second deflection point and the temperature of the first loss coefficient peak temperature is 10° or more and is outside the range of the above-described ◯ (Good).

X (Bad): The difference between the temperature of the second deflection point and the temperature of the first loss coefficient peak temperature is a value of below 10° C.

### Examples 2 to 8

Examples 2 to 8 were implemented in the same manner as in Example 1, except that various heat-shrinkable polyester films were produced in the same manner as in Example 1, by changing the type of each resin used and the like as shown in Table 1, and the thickness variation, the heat shrinkage ratios (A1 and A2), the storage modulus, and the like were evaluated. The results are shown in Tables 1 and 2.

That is to say, Example 2 was carried out in the same manner as in Example 1, except that 30 parts by weight of an amorphous polyester resin (PETG1) and 70 parts of a crystalline polyester resin (APET1) were mixed, and a heat-shrinkable polyester film was produced by using the mixture as a raw material and changing the extrusion conditions, and the viscoelastic characteristics and the like were evaluated as shown in FIG. 2B. The results are shown in Tables 1 and 2.

Furthermore, Example 3 was carried out in the same manner as in Example 1, except that instead of the crystalline polyester resin (APET1), 30 parts by weight of a crystalline polyester resin (APET2) was mixed, and a heat-shrinkable polyester film was produced by using the mixture as a raw material and changing the extrusion conditions, and the viscoelastic characteristics and the like were evaluated as shown in FIG. 2C. The results are shown in Tables 1 and 2.

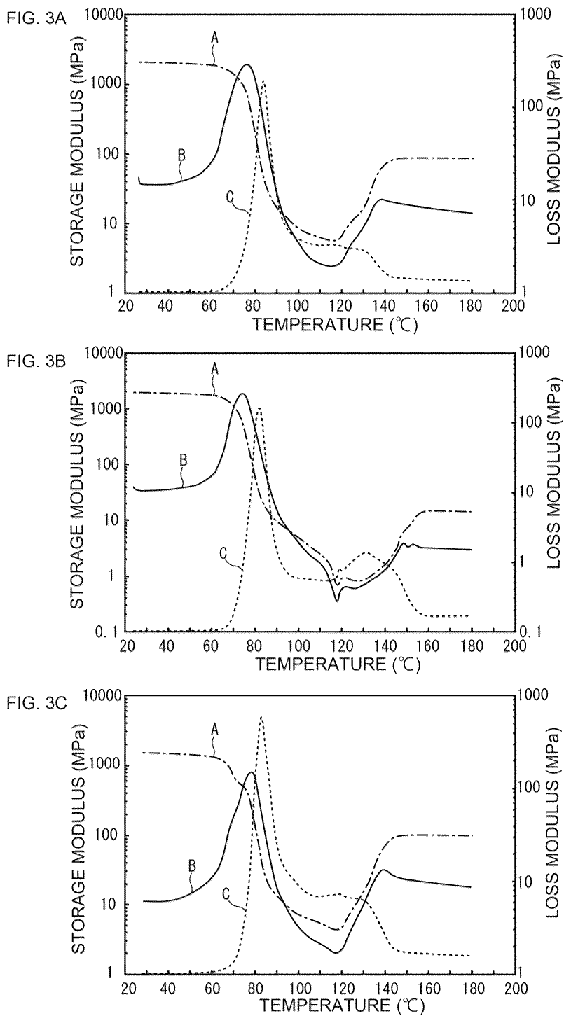

Furthermore, Example 4 was carried out in the same manner as in Example 1, except that instead of the crystalline polyester resin (APET1), a crystalline polyester resin (APET2) was used, and 30 parts by weight of an amorphous polyester resin (PETG1) and 70 parts by weight of a crystalline polyester resin (APET2) were mixed, and a heat-shrinkable polyester film was produced by using the mixture as a raw material and changing the extrusion conditions, and the viscoelastic characteristics and the like were evaluated as shown in FIG. 3A. The results obtained are shown in Tables 1 and 2.

Furthermore, Example 5 was carried out in the same manner as in Example 1, except that instead of the crystalline polyester resin (APET1), 30 parts by weight of a recycled crystalline polyester resin (PCR1) was mixed, and a heat-shrinkable polyester film was produced by using the mixture as a raw material and changing the extrusion conditions, and the viscoelastic characteristics and the like were evaluated as shown in Table 3B. The results obtained are shown in Tables 1 and 2.

Furthermore, Example 6 was carried out in the same manner as in Example 1, except that instead of the crystalline polyester resin (APET1), a recycled crystalline polyester resin (PCR1) was used, 30 parts by weight of an amorphous polyester resin (PETG1) and 70 parts by weight of a recycled crystalline polyester resin (PCR1) were mixed, and a heat-shrinkable polyester film was produced by using the mixture as a raw material and changing the extrusion conditions, and the viscoelastic characteristics and the like were evaluated as shown in FIG. 3C. The results obtained are shown in Tables 1 and 2.

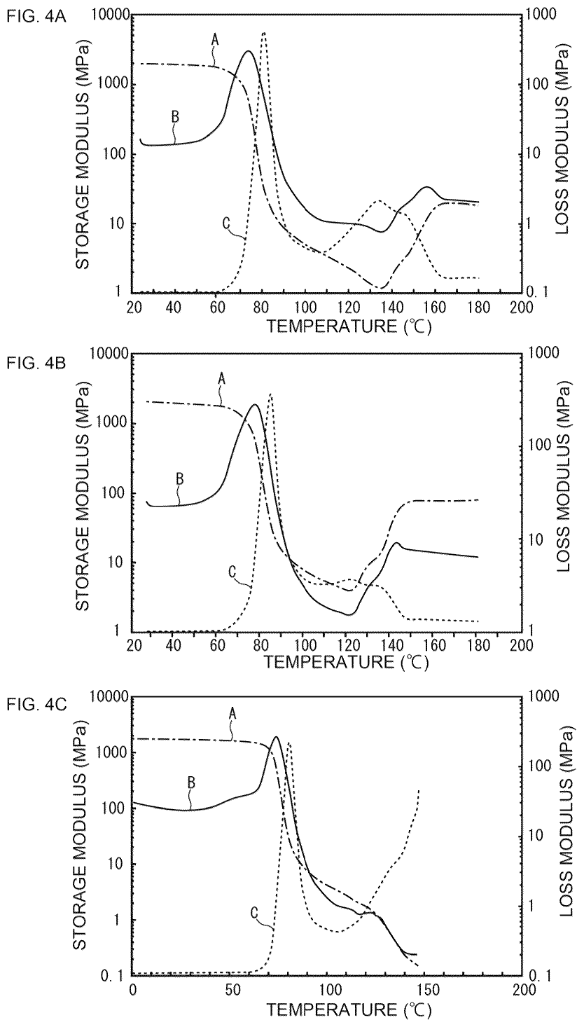

Furthermore, Example 7 was carried out in the same manner as in Example 1, except that instead of the crystalline polyester resin (APET1), 30 parts by weight of a recycled crystalline polyester resin (PCR2) was mixed, and a heat-shrinkable polyester film was produced by using the mixture as a raw material and changing the extrusion conditions, and the viscoelastic characteristics and the like were evaluated as shown in FIG. 4A. The results obtained are shown in Tables 1 and 2.

Furthermore, Example 8 was carried out in the same manner as in Example 1, except that instead of the crystalline polyester resin (APET1), a recycled crystalline polyester resin (PCR2) was used, 30 parts by weight of an amorphous polyester resin (PETG1) and 70 parts by weight of a recycled crystalline polyester resin (PCR2) were mixed, and a heat-shrinkable polyester film was produced by using the mixture as a raw material and changing the extrusion conditions, and the viscoelastic characteristics and the like were evaluated as shown in FIG. 4B. The results obtained are shown in Tables 1 and 2.

### Comparative Example 1

Comparative Example 1 was carried out in the same manner as in Example 1, except that various heat-shrinkable polyester films were produced in the same manner as in Example 1, by changing the type of the amorphous polyester resin as shown in Table 1, and the thickness variation, the heat shrinkage ratios (A1 and A2), the dynamic viscoelasticity measurement, and the like were evaluated in the same manner as in Example 1.

That is to say, Comparative Example 1 was carried out in the same manner as in Example 1, except that no crystalline polyester resin was used, 100 parts by weight of an amorphous polyester resin (PETG1) was used as a raw material, and a heat-shrinkable polyester film was produced by changing the extrusion conditions, and the viscoelastic characteristics and the like were evaluated as shown in FIG. 4C. The results obtained are shown in Tables 1 and 2.

TABLE 1

| | | | | | | Conditions for stretching in TD direction | | | | | | | | |
|---|---|---|---|---|---|---|---|---|---|---|---|---|---|---|
| | | | | | | | | | Thermal | | | | | |
| | | | | | | Preheating | | Stretching | fixing | | | | | |
| Intrinsic | Resin (pbw) | | | | | temper- | Stretch | temper- | temper- | | | | | |
| viscosity | PETG1 | APET1 | APET2 | PCR1 | PCR2 | ature | ratio | ature | ature | | | | | |
| (dL/g) | 0.78 | 0.65 | 0.71 | 0.72 | 0.82 | (° C.) | (%) | (° C.) | (° C.) | EVA 1 | EVA 2 | EVA 3 | EVA 4 | EVA 5 |
| Example | 70 | 30 | | | | 75 | 500 | 75 | 60 | Very | Very | Very | Good | Good |
| 1 | | | | | | | | | | good | good | good | | |
| Example | 30 | 70 | | | | 78 | 250 | 78 | 76 | Very | Very | Very | Good | Very |
| 2 | | | | | | | | | | good | good | good | | good |
| Example | 70 | | 30 | | | 75 | 500 | 75 | 60 | Very | Good | Very | Good | Good |
| 3 | | | | | | | | | | good | | good | | |
| Example | 30 | | 70 | | | 78 | 250 | 78 | 76 | Very | Good | Very | Good | Very |
| 4 | | | | | | | | | | good | | good | | good |
| Example | 70 | | | 30 | | 75 | 500 | 75 | 60 | Very | Very | Very | Very | Good |
| 5 | | | | | | | | | | good | good | good | good | |
| Example | 30 | | | 70 | | 78 | 250 | 78 | 76 | Very | Very | Very | Very | Good |
| 6 | | | | | | | | | | good | good | good | good | |
| Example | 70 | | | | 30 | 75 | 500 | 75 | 60 | Very | Very | Very | Very | Good |
| 7 | | | | | | | | | | good | good | good | good | |
| Example | 30 | | | | 70 | 78 | 250 | 78 | 76 | Very | Very | Very | Very | Very |
| 8 | | | | | | | | | | good | good | good | good | good |
| Compar- | 100 | | | | | 90 | 500 | 83 | 81 | Very | Good | Good | — | Fair |
| ative | | | | | | | | | | good | | | | |
| Example | | | | | | | | | | | | | | |
| 1 | | | | | | | | | | | | | | |

EVA 1: thickness variation,
EVA 2: heat shrinkage ratio A1,
EVA 3: heat shrinkage ratio A2,
EVA 4: intrinsic viscosity,
EVA 5: wrinkle resistance characteristics

TABLE 2

| | EVA 6 | | | | | | | | | | EVA 8 | | |
|---|---|---|---|---|---|---|---|---|---|---|---|---|---|
| | | | | | | | | | | | Temperature of | | |
| | | | | Temperature of | | EVA 7 | | | | | loss | | |
| | | | | deflection | | | | | Temperature of | | coefficient | | |
| | | | | point in | | | | | loss modulus | | peak (° C.) | | |
| | | | | storage modulus | | | | | peak (° C.) | | First | Second | |
| | | | | curve (° C.) | | | | | First | Second | loss | loss | |
| | | | | First | Second | | | | loss | loss | coeffi- | coeffi- | |
| | Storage modulus (MPa) | | | deflection | deflection | Loss modulus (MPa) | | | modulus | modulus | cient | cient | |
| | 50° C. | 70° C. | 80° C. | point | point | 50° C. | 70° C. | 80° C. | peak | peak | peak | peak | EVA 9 |
| Example | 1540 | 960 | 50 | 80 | 145.5 | 15 | 190 | 55 | 73.4 | 129.0 | Very | Very | Very |
| 1 | | | | | | | | | | | good | good | good |
| Example | 1490 | 1130 | 130 | 34 | 131 | 12 | 130 | 170 | 74.9 | 113.0 | Very | Fair | Very |
| 2 | | | | | | | | | | | good | | good |
| Example | 1700 | 1100 | 40 | 78.5 | 142 | 18 | 90 | 220 | 72.9 | 127.0 | Very | Very | Very |
| 3 | | | | | | | | | | | good | good | good |
| Example | 1950 | 1400 | 200 | 82 | 130 | 18 | 180 | 210 | 76.2 | 117.0 | Very | Good | Very |
| 4 | | | | | | | | | | | good | | good |
| Example | 1800 | 1160 | 180 | 84 | 143 | 14 | 94 | 140 | 73.6 | 118.8 | Very | Good | Very |
| 5 | | | | | | | | | | | good | | good |
| Example | 1420 | 710 | 140 | 82.5 | 132 | 7.3 | 48 | 130 | 77.9 | 119.0 | Very | Very | Very |
| 6 | | | | | | | | | | | good | good | good |
| Example | 1900 | 1150 | 60 | 80 | 150 | 17 | 210 | 110 | 73.4 | 136.0 | Very | Good | Very |
| 7 | | | | | | | | | | | good | | good |
| Example | 1870 | 1330 | 200 | 82.5 | 130 | 28 | 150 | 230 | 76.2 | 121.0 | Very | Very | Very |
| 8 | | | | | | | | | | | good | good | good |
| Compar- | 1620 | 1150 | 30 | 80 | — | 35 | 170 | 50 | 74 | — | Very | — | — |
| ative | | | | | | | | | | | good | | |
| Example | | | | | | | | | | | | | |
| 1 | | | | | | | | | | | | | |

EVA 6: storage modulus,
EVA 7: loss modulus,
EVA 8: loss coefficient,
EVA 9: temperature difference between second deflection point and first loss coefficient peak

### Examples 9 and 10

In Examples 9 and 10, heat-shrinkable polyester films were produced in the same manner as in Example 1, except that PETG1 as the amorphous polyester was changed to PETG2 and PETG3, respectively, and were evaluated.

As a result, it was verified that the results of the thickness variation, heat shrinkage ratios (A1 and A2), dynamic viscoelasticity measurement, and the like thus obtained were almost similar to those of Example 1.

### Comparative Examples 2 and 3

In Comparative Examples 2 and 3, heat-shrinkable polyester films were produced in the same manner as in Example 1, except that PETG1 as the amorphous polyester was changed to PETG2 and PETG3, respectively, and were evaluated.

As a result, it was verified that in Comparative Examples 2 and 3, results of the thickness variation, heat shrinkage ratios (A1 and A2), dynamic viscoelasticity measurement, and the like thus obtained were almost similar to those of Comparative Example 1.

### INDUSTRIAL APPLICABILITY

According to the present invention, with regard to a heat-shrinkable polyester film derived from a predetermined polyester resin composition, the heat shrinkage characteristics, the wrinkle resistance characteristics, and the like can be managed efficiently and precisely by measuring loss coefficients and the like in a plurality of temperature regions by using a dynamic viscoelasticity measuring apparatus, and controlling each of them to be within a predetermined range.

Therefore, when the heat-shrinkable polyester film of the present invention is used, the film can be applied to various PET bottles and the like, general-purpose usability thereof can be markedly expanded, and it can be said that industrial applicability of the film is very high.

1. A heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a) to (c):
configuration (a): a loss coefficient obtained using a dynamic viscoelasticity measuring apparatus according to JIS K 7244-4 has a first loss coefficient peak in a temperature region of below 100° C.;
configuration (b): the loss coefficient obtained using a dynamic viscoelasticity measuring apparatus according to JIS K 7244-4 has a second loss coefficient peak in a temperature region of 100° C. or higher; and
configuration (c): a heat shrinkage ratio in a main shrinkage direction obtained when the film is immersed in hot water at 80° C. for 10 seconds is 30% or more.

2. The heat-shrinkable polyester film according to claim 1, wherein the temperature region of below 100° C. having the first loss coefficient peak has a value within a range of 70° C. to 90° C.

3. The heat-shrinkable polyester film according to claim 1, wherein the temperature region of 100° C. or higher having the second loss coefficient peak has a value within a range of 120° C. to 160° C.

4. The heat-shrinkable polyester film according to claim 1, wherein in a case where a height of the first loss coefficient peak is 100, a height of the second loss coefficient peak has a value within a range of 20 to 50.

5. The heat-shrinkable polyester film according to claim 1, wherein an intrinsic viscosity of the amorphous polyester resin has a value within a range of 0.6 to 0.85 dL/g, and an intrinsic viscosity of the crystalline polyester resin has a value within a range of 0.6 to 0.85 dL/g.

6. The heat-shrinkable polyester film according to claim 1, wherein the crystalline polyester resin is a homo-PET resin and a PCRPET resin, or any one of them.

7. A heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a′) to (c′):
configuration (a′): a storage modulus curve obtained using a dynamic viscoelasticity measuring apparatus according to JIS K 7244-4 has a first deflection point at which a storage modulus decreases, in a temperature region of below 100° C.;
configuration (b′): a storage modulus curve obtained using a dynamic viscoelasticity measuring apparatus according to JIS K 7244-4 has a second deflection point at which a storage modulus increases, in a temperature region of 100° C. or higher; and
configuration (c′): a heat shrinkage ratio in a main shrinkage direction obtained when the film is immersed in hot water at 80° C. for 10 seconds is 30% or more.

8. A heat-shrinkable polyester film derived from a polyester resin composition containing 30% to 90% by weight of an amorphous polyester resin and 10% to 70% by weight of a crystalline polyester resin with respect to a total amount (100% by weight), the heat-shrinkable polyester film satisfying the following configurations (a″) to (c″):
configuration (a″): a loss modulus curve obtained using a dynamic viscoelasticity measuring apparatus according to JIS K 7244-4 has a first loss modulus peak in a temperature region of below 100° C.;
configuration (b″): a loss modulus curve obtained using a dynamic viscoelasticity measuring apparatus according to JIS K 7244-4 has a second loss modulus peak that is convex-shaped in a direction inverse to the first loss modulus peak, in a temperature region of 100° C. or higher; and
configuration (c″): a heat shrinkage ratio in a main shrinkage direction obtained when the film is immersed in hot water at 80° C. for 10 seconds is 30% or more.
